(19) United States
(12) Patent Application Publication
(10) Pub. No.: US 2011/0168883 A1
(43) Pub. Date: Jul. 14, 2011

(54) MASS SPECTROMETER

(75) Inventors: Osamu FURUHASHI, Uji-shi (JP); Takahiro HARADA, Uji-shi (JP); Kiyoshi OGAWA, Kizugawa-shi (JP); Koichi TANAKA, Kyoto-shi (JP)

(73) Assignee: SHIMADZU CORPORATION, Nakagyo-ku (JP)

(21) Appl. No.: 12/026,626

(22) Filed: Feb. 6, 2008

(30) Foreign Application Priority Data
Feb. 7, 2007 (JP) 2007-028153

(51) Int. Cl. H01J 49/26

(52) U.S. Cl. 250/288

(57) ABSTRACT

A mass spectrometer is provided that restrains the signal intensity of an MS/MS spectrum from decreasing according to the secondary dissociation of a primary fragment ion generated by a photodissociation. An excitation laser light for causing a photodissociation is irradiated to the trapping space A in the ion trap 1. At the same time, an excitation signal that does not excite a precursor ion but excites fragment ions is applied to the end cap electrodes 12 and 13. Since the selected precursor ions gather around the center of the trapping space A, they are irradiated by the excitation laser light and efficiently dissociated. The fragment ions generated by this are immediately excited by the excitation electric field's effect, and are vibrated wildly to be out of the excitation light irradiated space B. Therefore, the fragment ions are not easily irradiated by the excitation laser light and the secondary dissociation does not easily occur.

### BACKGROUND OF THE INVENTION

The present invention relates to a mass spectrometer, and more specifically to a mass spectrometer using photodissociation for dissociating ions trapped in an ion trap.

An MS/MS analysis (or tandem analysis) is a type of mass-analyzing method. In a typical MS/MS analysis, an ion having a specific mass is first selected as a precursor ion. Then, the precursor ion is broken (fragmented) into various product ions (or fragment ions). Finally, the product ions (or fragment ions) are subjected to a mass-analyzing process. One of the most widely used methods for dissociating a precursor ion is a collision-induced dissociation (CID) process in which a precursor ion is made to collide with gas atoms or molecules.

Photodissociation is also one of the methods for dissociating an ion by irradiating an excitation light onto an ion to increase its internal energy. Photodissociation includes ultraviolet light dissociation and Infrared Multiphoton Dissociation (IRMPD). In ultraviolet light dissociation, an ultraviolet light as excitation light is irradiated onto an ion. Then the electronic state of the ion is excited and the dissociation is accelerated. In IRMPD, an intense infrared light as excitation light is irradiated onto an ion in order to make the ion sequentially absorb multiple photons. Then the vibrational state of the ion is excited and the dissociation is accelerated (See Non-Patent Document 1 for example). In a mass spectrometer of a three-dimensional quadrupole type or the like, it is possible to entrap and hold ions in a comparatively narrow space. Hence, it is easy to irradiate an excitation light onto one same ion for a comparatively long period of time. For this reason, an MS/MS analysis (or an MS′ analysis in which dissociations are taking place in multiple stages) often employs photodissociation (mainly IRMPD).

When performing a collision-induced dissociation process inside of an ion trap, the frequency of a resonant excitation signal in the ion trap is generally adjusted to the mass of precursor ions to be analyzed. This selectively excites only the precursor ions and makes them collide with gas atoms or molecules. The dissociation (primary dissociation) is accordingly accelerated. In this case, fragment ions with smaller mass which were produced by the primary dissociation are not excited so much that they do not energetically collide with gas atoms or molecules and a secondary dissociation, or a further dissociation, does not occur.

On the other hand, when a photodissociation is performed inside an ion trap, fragment ions produced by a precursor ion's dissociation (primary dissociation) by a light absorption are irradiated with an excitation light together with precursor ions. Therefore, a secondary dissociation in which a fragment ion is further photo-dissociated easily occurs. In the case where such a secondary dissociation takes place, the signal intensity of a fragment ion (primary fragment ion) produced by a primary dissociation decreased in an MS/MS spectrum as illustrated in FIG. 9. This results in the severe deterioration of the S/N of a mass spectrum.
Non-Patent Document 1: L. Sleno et al., “Ion activation methods for tandem mass spectrometry”, Journal of Mass Spectrometry, 39 (2004), pp. 1091-1112

### SUMMARY OF THE INVENTION

The present invention has been achieved in view of the aforementioned problems, and a main objective thereof is to provide a mass spectrometer that enhances the S/N of an MS/MS spectrum by enhancing the primary dissociation of a precursor ion and restraining the secondary dissociation as much as possible when a photodissociation is carried out inside an ion trap for trapping ions.

A first aspect of the present invention to solve the above-described problem provides a mass spectrometer for mass-analyzing ions generated by a dissociation in an ion trap, including:

an ion trap for trapping ions in a space surrounded by a plurality of electrodes;

an excitation light emitter for irradiating an excitation light for photo-dissociating ions to a center of a trapping space of the ion trap; and

an excitation signal generator for generating an excitation signal having a predetermined frequency that does not make precursor ions to be analyzed resonantly vibrate and selectively make fragment ions generated by a photodissociation resonantly vibrate, and for applying the excitation signal to at least one of the electrodes of the ion trap.

A second aspect of the present invention to solve the above-described problem provides a mass spectrometer for mass-analyzing ions generated by a dissociation in an ion trap, including:

an ion trap for trapping ions in a space surrounded by a plurality of electrodes;

an excitation light emitter for irradiating an excitation light for photo-dissociating ions to a space off a center of a trapping space of the ion trap; and

an excitation signal generator for generating an excitation signal having a predetermined frequency that selectively makes precursor ions to be analyzed resonantly vibrate to reach the excitation light irradiated space and does not make fragment ions generated by a photodissociation resonantly vibrate, and for applying the excitation signal to at least one of the electrodes of the ion trap.

In the mass spectrometer according to the first aspect of the present invention, ions to be analyzed are first trapped as a precursor ion in the ion trap. The selection of the precursor ions may be carried out either inside or outside the ion trap. In each case, the precursor ions concentratedly (i.e. with high probability) exist around the center of the trapping space of the ion trap. The excitation light emitter irradiates an excitation light to the center of the trapping space. At the same time, the excitation signal generator generates an excitation signal having a frequency that does not make the precursor ions to be analyzed resonantly vibrate but make fragment ions with smaller mass resonantly vibrate. The excitation signal generator applies the excitation signal to at least one of the electrodes that are included in the ion trap. For example, in the case where the ion trap is a three-dimensional quadrupole type ion trap with one ring electrode and two end cap electrodes, the excitation signal may be applied between both end cap electrodes because a trapping electric field is normally formed by applying an RF voltage for trapping ions to the ring electrode.

The precursor ions concentratedly existing around the center of the trapping space are irradiated with the excitation light, and dissociated by a photodissociation (primary dissociation) to generate fragment ions. Since the precursor ions are not effected by the electric field formed by the excitation signal, they do not vibrate wildly and they effectively receive the excitation light to be photo-dissociated. On the other hand, since the fragment ions generated by this are affected by the excitation electric field, they immediately begin to vibrate wildly and go out of the center of the trapping space. Accordingly, they are not easily irradiated with the excitation light. Hence, it is possible to restrain fragment ions from being irradiated by the excitation light to be secondary-dissociated. Although a fragment ion may pass through the excitation light irradiated space (area to which the excitation light is irradiated), the transit time is generally short. Hence, the fragment ion is not easily excited and dissociated.

However, the reaction rate of a photodissociation varies according to ion species. Some kinds of generated fragment ions may be secondary-dissociated before they have been made to resonantly vibrate to have a vibration amplitude large enough to go out of the excitation light irradiated space. Hence, the mass spectrometer according to the first aspect of the present invention may further include a gas introducer for introducing a predetermined gas into the ion trap in order to control the reaction rate of the photodissociation.

An introduction of a buffer gas into the ion trap during the photodissociation in this configuration retards the ion's photodissociation reaction since the internal energy of an ion that has increased by absorbing a photon for example is taken away by contacting the buffer gas. As a result, if the excitation light hits a fragment ion generated by a primary dissociation as described earlier, since the time period until the secondary dissociation occurs is elongated, a large vibration amplitude can be given to the fragment ion to go out from the excitation light irradiated space before it is secondary-dissociated. Accordingly, it is possible to further restrain the secondary dissociation of the fragment ions.

In the mass spectrometer according to the second aspect of the present invention, ions to be analyzed are first trapped as precursor ions in the ion trap. The selection of the precursor ions may be carried out either inside or outside the ion trap. In each case, the precursor ions concentratedly exist around the center of the trapping space of the ion trap. The excitation light emitter irradiates an excitation light to miss the center of the trapping space. That is, the excitation light is irradiated to an area surrounding the center. At the same time, the excitation signal generator generates an excitation signal having a frequency that selectively makes the precursor ion resonantly vibrate, and applies it to at least one of the electrodes that constitute the ion trap. For example, in the case where the ion trap is a three-dimensional quadrupole type ion trap with one ring electrode and two end cap electrodes, the excitation signal may be applied between the both end cap electrodes.

Since precursor ions are excited by the effect of an electric field formed inside the ion trap by the excitation signal, they do not remain in the center of the trapping space, but go into the previously described excitation light irradiated space. The precursor ions are irradiated by the excitation light in that area, and are dissociated by a photodissociation (primary dissociation) to generate fragment ions. On the other hand, since the generated fragment ions are not excited by the effect of the aforementioned excitation electric field, they are affected by the trapping electric field and concentratedly gather around the center of the trapping space. Accordingly, the fragment ions are not easily irradiated by the excitation light, and it is possible to restrain the secondary dissociation of fragment ions.

In a preferable embodiment of the second aspect of the present invention, the excitation light emitter may irradiate the excitation light to surround the center of the trapping space of the ion trap. Specifically, the excitation light irradiated area is circular-shaped, and the irradiated area may be preferably set so that the center portion to which the excitation light is not irradiated is placed in the middle of the trapping space.

In this configuration, when a selectively excited precursor ion goes out from the center of the trapping space, it is irradiated by the excitation light with higher probability. Accordingly, the precursor ion's dissociation efficiency is increased.

In the mass spectrometer according to the second aspect of the present invention, for example, the ion trap may be a three-dimensional quadrupole type ion trap with one ring electrode and two end cap electrodes, or a linear ion trap in which a plurality of rod electrodes with curved inner surface are aligned parallel. In each case, the size of the area in which an ion exists with high probability around the center of the trapping space of the ion trap is almost determined as a certain portion of the distance between the electrodes.

Hence, in order to prevent the fragment ions generated by the primary dissociation from being irradiated with the excitation light, it is preferable that the space to which the excitation light is irradiated by the excitation light emitter be located away from the center of the trapping space of the ion trap by 2.5% or above the distance between the two end cap electrodes in the case where a three-dimensional quadrupole type ion trap is used. In the case where a linear ion trap is used, it is preferable that the space to which the excitation light is irradiated by the excitation light emitter be located away from the center of the trapping space of the ion trap by 2.5% or above the distance between inner curved surfaces of two facing rod electrodes.

With the mass spectrometers according to the first and second aspects of the present invention, it is possible to restrain fragment ions, which were generated by photo-dissociation when a precursor ion is irradiated by an excitation light, from being further dissociated (secondary dissociation). Accordingly, the signal intensity of the fragment ions' peaks does not decrease when an MS/MS spectrum is created. This ensures a high S/N.

In the mass spectrometers according to the first and second aspects of the present invention, two or more excitation light emitters may be provided, and the excitation signal generator may generate an excitation signal including two or more frequencies each corresponding to an ion to be resonantly vibrated. The ions to be resonantly vibrated include fragment ions of different kinds generated from a precursor ion, or plural precursor ions when a target ion is accompanied by molecular-related ions such as adduct ions or ions devoid of water molecule(s).

### BRIEF DESCRIPTION OF THE DRAWINGS

FIG. 1 is a schematic configuration diagram of an ion trap time-of-flight mass spectrometer according to an embodiment (first embodiment) of the first aspect of the present invention.

FIG. 2A is a schematic diagram for spatially illustrating the relation between the ion trapping space and the excitation light irradiated space within the ion trap of the mass spectrometer of the first embodiment.

FIG. 2B is a diagram illustrating the relation between the ion trapping space and the excitation light irradiated space on the ion's existence probability.

FIG. 3 is a diagram illustrating an example of a frequency characteristic of an excitation signal in the mass spectrometer of the first embodiment.

FIGS. 4A, 4B and 4C illustrate measurement results of the peak intensity's variation of a precursor ion and four kinds of fragment ions when an irradiation time of an infrared laser as an excitation laser is changed.

FIG. 5 is a schematic configuration diagram of an ion trap time-of-flight mass spectrometer according to an embodiment (second embodiment) of the second aspect of the present invention.

FIG. 6 is a schematic diagram for spatially illustrating the relation between an ion trapping space and an excitation light irradiated space within the ion trap of the mass spectrometer of the second embodiment.

FIG. 7 is a schematic configuration diagram of an ion trap of a mass spectrometer according to another embodiment of the second aspect of the present invention.

FIG. 8 is a schematic configuration diagram of an ion trap of a mass spectrometer according to further another embodiment of the second aspect of the present invention.

FIG. 9 is a diagram for explaining a signal intensity's reduction by a secondary dissociation.

### EXPLANATION OF THE NUMERALS

1 . . . Ion Trap
11 . . . Ring Electrode
12, 13 . . . End Cap Electrode
14 . . . Entrance Aperture
15 . . . Exit Aperture
16, 17, 18 . . . Laser Irradiation Aperture
2 . . . Ion Source
20 . . . RF Voltage Generator
21, 25 . . . Excitation Signal Generator
22, 26 . . . Excitation Laser Emission Source
23 . . . Gas Introducer
24 . . . Controller
3 . . . Time-Of-Flight Mass Spectrometer
4 . . . Flight Space
5 . . . Ion Detector

### DETAILED DESCRIPTION OF A PREFERRED EMBODIMENT

Embodiments of a mass spectrometer according to the present invention will be explained hereinafter with reference to figures.

### First Embodiment

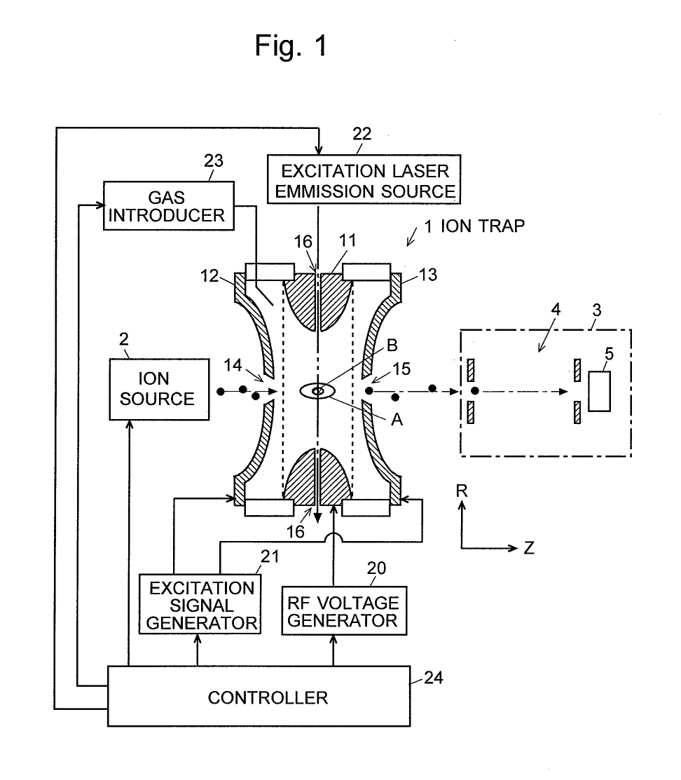

FIG. 1 is a schematic configuration diagram of an ion trap time-of-flight mass spectrometer (IT-TOFMS) according to an embodiment (the first embodiment) of the first aspect of the present invention.

Inside an evacuated vacuum chamber (not shown), a three-dimensional quadrupole type ion trap 1 is disposed. The ion trap 1 is composed of a ring electrode 11 and a pair of end cap electrodes 12, 13 opposing each other (right and left in FIG. 1) with the ring electrode therebetween. The inner surface of the ring electrode is formed hyperboloid-of-one-sheet-of-revolution and the inner surface of the end cap electrodes are formed hyperboloid-of-two-sheets-of-revolution. These electrodes 11, 12, and 13 form a trapping space A for trapping ions by a trapping electric field in the space surrounded thereby.

Outside an entrance aperture 14 bored through the entrance-side end cap electrode 12, an ion source 2 such as a MALDI for example is placed. On the other hand, outside an exit aperture 15 bored thorough the exit-side end cap electrode 13, a time-of-flight mass spectrometer 3 including a flight space 4 for separating ions according to their mass-to-charge ratios and an ion detector 5 are placed. The ion source 2 is not limited to a MALDI, and various types of known ion sources may be used in its place. The time-of-flight mass spectrometer 3 may be replaced with one of the other types of mass spectrometers. Alternatively, it is possible to place only an ion detector outside of the exit aperture 15, regarding the ion trap 1 itself as a mass spectrometer.

In the center of the ring electrode 11 along the axis (R-axis) of the ring electrode 11, a laser irradiation aperture 16 is bored. A laser light as an excitation light emitted by the excitation laser emission source 22 flies through the laser irradiation aperture 16 to the core (center of the trapping space A) of the ion trap 1. Accordingly, the laser light irradiates (flies through) the core of the ion trap 1. A gas introducer 23 provides a buffer gas to the inside of the ion trap 1.

An RF voltage generator 20 is connected to the ring electrode 11, and an excitation signal generator 21 is connected to both of the end cap electrodes 12, 13. The RF voltage generator 20 and the excitation signal generator 21 are respectively controlled by a control signal provided by a controller 24 to generate an alternating voltage having a predetermined frequency and predetermined amplitude. It is possible to superpose a direct current voltage to the alternating voltages according to necessity. The controller 24 includes a CPU, RAM, and other components, and controls the RF voltage generator 20 and the excitation signal generator 21 based on a preset control program. The controller 24 also controls the operation of the ion source 2, the excitation laser emission source 22, the gas introducer 23, and other components.

The operation for obtaining an MS/MS spectrum of an ion having a specific mass with this IT-TOFMS will be explained.

First, a buffer gas such as He is introduced in a pulsed manner from the gas introducer 23 to fill the ion trap 1 under the control of the controller 24. Then, a predetermined RF voltage is applied from the RF voltage generator 20 to the ring electrode 11 to form a quadrupole type electric field for trapping ions. From this state, when various ions generated from a sample to be analyzed in the ion source 2 are introduced into the ion trap 1 through the entrance aperture 14, the ions collide with the buffer gas and lose their kinetic energy, or “cooled”. The ions are eventually trapped in the quadrupole type electric field and gather around the center of the trapping space A.

After such various kinds of ions are trapped in the trapping space A within the ion trap 1, an excitation signal for making ions other than precursor ions vibrate wildly is generated by the excitation signal generator 21, and is applied to the end cap electrodes 12 and 13 in order to make only precursor ions remain within the ion trap 1. Undesired ions other than the precursor ions to be targeted are consequently dispersed to the outside of the ion trap 1 via the entrance aperture 14 and the exit aperture 15.

After the precursor ions are selected as just described, the excitation laser emission source 22 is driven, so as to photo-dissociate the selected precursor ions, to irradiate an excitation laser light to the center of the trapping space A (an excitation light irradiated space B) within the ion trap 1. At the same time, an excitation signal having a frequency that does not make the precursor ions vibrate but makes fragment ions vibrate that were generated in the primary dissociation of the precursor ions is generated in the excitation signal generator 21, and is applied to the end cap electrodes 12 and 13. The details of the excitation signal will be specifically explained later.

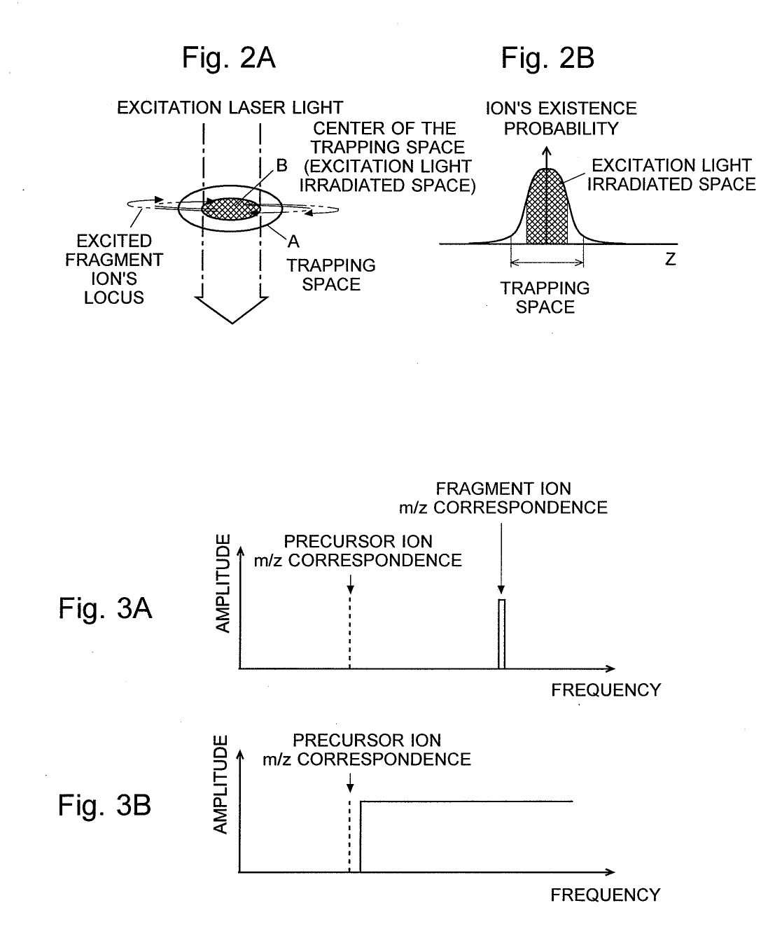

FIG. 2A is a schematic diagram for spatially illustrating the relation between an ion trapping space A and an excitation light irradiated space B within the ion trap of the mass spectrometer of the first embodiment. FIG. 2B is a diagram illustrating the relation between the ion trapping space A and the excitation light irradiated space B on the ion's existence probability. As illustrated in FIG. 2B, most of the ions that are not excited exist within the trapping space A and they especially exist in the center portion the trapping space A with high probability. Since an excitation laser light is irradiated to this space, the laser light efficiently hits the precursor ions that are not excited, and their photodissociation is accelerated. This makes the precursor ions dissociated to generate fragment ions with a smaller mass.

Although the fragment ions are also trapped by the trapping electric field, they are in addition affected by the electric field formed by the excitation signal and begin to vibrate wildly in the Z-direction. Hence, as illustrated in FIG. 2A, the fragment ions are off the excitation light irradiated space B for a long time. Therefore, they are not easily secondary-dissociated by a photodissociation. That is, it is possible to photo-dissociate precursor ions with high probability, and to restrain the primary fragment ions generated by the photodissociation from being photo-dissociated.

Since the photodissociation of precursor ions occurs within the excitation light irradiated space, however, if it takes too much time to make generated fragment ions vibrate with an amplitude significant enough to be out of the excitation light irradiated space, a secondary dissociation may take place. The reaction rate of a photodissociation varies according to ionic species; a fragment ion having a high reaction rate in particular is more likely to be secondary dissociated. Hence, it is preferable to introduce a small amount of buffer gas into the ion trap 1 when the laser light is emitted in order to deliberately restrain the fragment ion's secondary dissociation, although it is preferable in general to keep the inside of the ion trap 1 in a high-vacuum state when a photodissociation is accelerated by irradiating an excitation laser light.

If a buffer gas is introduced into the ion trap 1, the reaction rate of a photodissociation decreases because ions that have absorbed photons gain the internal energy and become more likely to collide with the buffer gas to be relaxed from the excitation state. Hence, although the efficiency of the primary dissociation of precursor ions themselves decreases, the secondary dissociation of the primary fragment ions is further restrained as well. Although such effects are put out in an ultraviolet light dissociation as well, it is more prominent and effective in Infrared Multiphoton Dissociation in particular.

After the precursor ions are dissociated by a photodissociation for a predetermined period of time as described earlier, a voltage capable of evacuating the ions trapped within the ion trap 1 is applied to the end cap electrodes 12 and 13. An initial kinetic energy is accordingly given to the fragment ions and they are collectively emitted from the exit aperture 15 and introduced into the time-of-flight mass spectrometer 3 to be mass-analyzed. Then, an MS/MS spectrum is created by processing the detection signals from the ion detector 5 by a data processor (not shown).

Examples of an excitation signal to be applied to the end cap electrodes 12 and 13 on a photodissociation will be explained. In the case where the mass of the fragment ions generated by a precursor ion's dissociation is known in advance, a sine wave signal having a frequency that corresponds to the resonance frequency of the fragment ions can be used as an excitation signal in order to selectively make only the fragment ions vibrate. For example, when only one kind of fragment ion is included, a sine wave signal (or a rectangular wave signal or the like) having a single frequency can be used as an excitation signal as illustrated in FIG. 3A. When plural kinds of fragment ions are included, different sine wave signals, each signal having a single frequency, may be synthesized to be used as an excitation signal.

In the case where the mass of the fragment ions are unknown or the number of masses are many, a broadband signal without the frequency corresponding to the resonant frequency (in practice, without a predetermined width of frequencies around the resonant frequency) of a precursor ion may be preferably used as an excitation signal. Such broadband signal may be generated by using a known method, for example, disclosed in Japanese Patent No. 3470671.

Next, an experimental result for verifying the effect of the mass spectrometer according to the first aspect of the present invention will be explained.

In this experiment, reserpine (molecular weight: 608) was used as a sample, and electrospray ionization (ESI) ion source was used as an ion source. Proton-added ions (m/z 609) generated by this ion source were left as precursor ions within an ion trap. Then an infrared laser light as an excitation laser light was irradiated to make them infrared-multiphoton dissociated. It is known that fragment ions with mass-to-charge ratio m/z of 236, 397, and 448 are generated when reserpine is dissociated by a collision induced dissociation. It is also known that a peak of m/z 363 is observed in addition other than the four peaks after an infrared multiphoton dissociation.

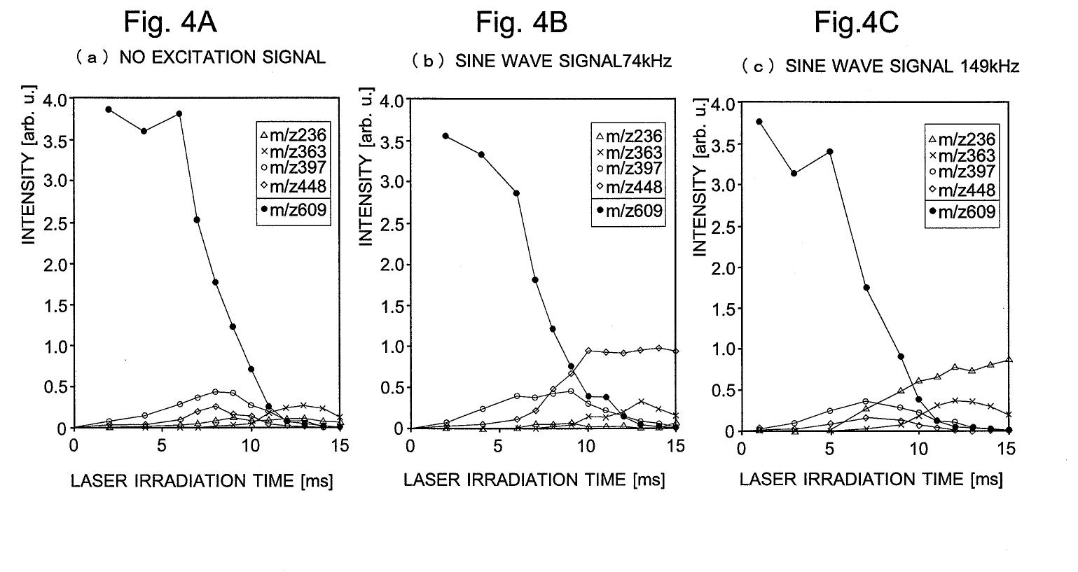

FIG. 4 illustrates the measurement results of the peak intensity's variation of a precursor ion (m/z 609) and four kinds of fragment ions (m/z 236, 363, 397, and 448) when the irradiation time of an infrared laser as an excitation laser was changed. FIG. 4A is a result in the case where no excitation signal was applied when an infrared-multiphoton dissociation was taking place. That is, FIG. 4A is a result of a conventional method. The longer the laser irradiation time became, the higher the internal energy of the precursor ions accordingly became and the weaker the peak intensity became since an infrared-multiphoton dissociation began to take place. In contrast to the decrease, the peak intensity of the fragment ions (m/z 236, 397, and 448) generated in the primary dissociation increased in a range where the laser irradiation time was shorter than a certain time. However, if the laser irradiation time became longer than that previously mentioned, the peak intensity of primary fragment ions decreased based on an effect of a secondary dissociation. After the peak intensity of other fragment ions shifted to a decreasing rate, the peak intensity of a fragment ion of m/z 363 began to increase as if replacing them. Therefore, it is possible to presume that this was a secondary fragment ion generated by a secondary dissociation.

It is understood that, in this example, approximately 8 ms of laser irradiation time is necessary to maximize the peak intensity of the fragment ions by a primary dissociation. In this case, however, half of the precursor ions still remained undissociated, and the dissociation efficiency was not very high.

FIG. 4B is a result obtained in the case where a sine wave signal of frequency 74 kHz as an excitation signal was applied between the end cap electrodes so that fragment ions of mass-to-charge ratio of m/z 448 were selectively resonantly vibrated. An infrared laser light was irradiated at the same time. The peak intensity's change of the fragment ions (m/z 236, 397) other than m/z 448 can be regarded a fluctuation of a signal intensity, and was as much as that of FIG. 4A. In contrast, since a fragment ion of m/z 488 was selectively excited to be out of the infrared irradiated space, it was barely affected by a secondary dissociation. Therefore, the peak intensity increased almost monotonically as the laser irradiation time became longer. In the case where the laser irradiation time was longer than 10 ms, the peak intensity was saturated. Therefore, the peak intensity's decrease by a secondary dissociation did not occur as for the fragment ion of m/z 448.

FIG. 4C is a result obtained in the case where a sine wave signal of frequency 149 kHz as an excitation signal was applied between the end cap electrodes so that fragment ions of mass-to-charge ratio of m/z 236 were selectively resonantly vibrated. In this case, only the fragment ion of m/z 236 was not affected by a secondary dissociation, and its signal intensity monotonically increased as the laser irradiation time became longer.

The result indicates that the fragment ions selectively vibrated while an infrared multiphoton dissociation is occurring are not affected by a secondary dissociation and a high peak intensity can be therefore assured. In this experiment, a sine wave signal with a single frequency was applied as an excitation signal to the end cap electrodes to restrain a predetermined fragment ion's secondary dissociation, in order to clearly show the fundamental effect of the present invention. However, in order to increase the signal intensity by restraining the secondary dissociation's affect as for plural or many fragment ions, a broadband signal as described earlier (synthetic waveform of discrete frequencies across a broadband without a resonant frequency of a precursor ion) may be applied to the end cap electrodes as an excitation signal as a matter of course.

### Second Embodiment

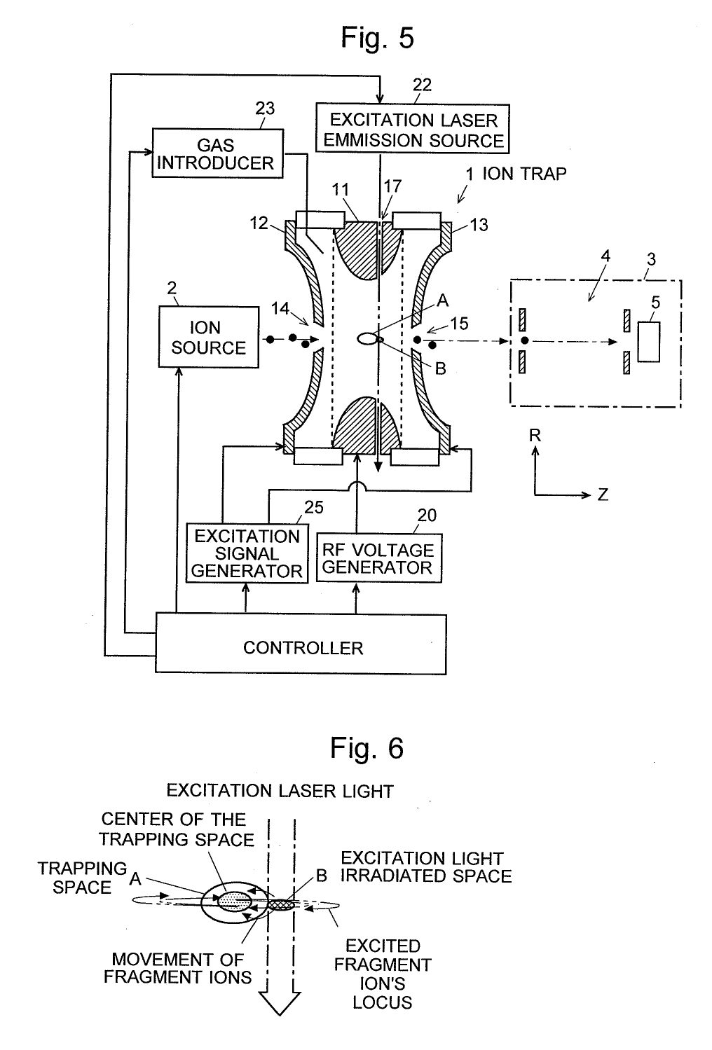

FIG. 5 is a schematic configuration diagram of an ion trap time-of-flight mass spectrometer (IT-TOFMS) according to an embodiment (the second embodiment) of the second aspect of the present invention. In FIG. 5, like elements are denoted by like numerals as in the first embodiment which was described earlier.

One of the essential differences between the second embodiment and the first is that the excitation laser light is not irradiated to the center of the trapping space A of the ion trap 1, but is purposely irradiated to the area off the center. For this purpose, the laser irradiation aperture 17 is placed off the center axis of the ring electrode 11. In addition, the excitation signal generator 25 applies an excitation signal having a frequency that selectively makes a precursor ion to be targeted vibrate (but not making a fragment ion vibrate) to the end cap electrodes 12 and 13 when making a photodissociation occur by irradiating a laser light. In this case, the excitation signal can be generated easier than the first embodiment since a sine wave signal with a single frequency or a rectangular wave signal will do.

FIG. 6 is a schematic diagram for spatially illustrating the relation between the ion trapping space A and the excitation light irradiated space B within the ion trap. When the excitation signal is applied to the end cap electrodes 12 and 13, the precursor ions vibrate wildly in the Z-axis direction by the effect of the excitation electric field formed within the ion trap 1. If no excitation signal is applied, precursor ions do not enter the excitation light irradiated space B; if the precursor ions are excited, they pass through the excitation light irradiated space B, then absorb photons during the crossing, and are presently photo-dissociated. This generates fragment ions, and such fragment ions are not affected by the excitation electric field and do not vibrate wildly although they are affected by the capturing electric field by the RF voltage applied to the ring electrode 11. The fragment ions consequently gather around the center of the ion trapping space A. That is, the fragment ions are not easily secondary dissociated since they are out of the excitation light irradiated space B and are not irradiated by the excitation laser light. Therefore, the amount of the primary fragment ions increases as the laser irradiation time becomes longer, which enhances the S/N of an MS/MS spectrum.

According to a simulated calculation by the inventors of the present invention, when the distance between the two end cap electrodes 12 and 13 was 20 mm, the spread width of the ion cloud that was sufficiently cooled by a collision with a buffer gas was under ±0.5 mm from the center of the ion trap 1. Hence, if the irradiated area by an excitation laser is away from the center area of the ion trap 1 by 0.5 mm or greater, the secondary dissociation which occurs when an excitation laser light hits fragment ions can be efficiently avoided. Since it is possible to consider that the same model is established with different sizes of the ion trap 1, if the excitation light irradiated space B is off the center of the ion trap 1 by 2.5% or above the distance between the end cap electrodes, the effect of restraining secondary dissociation is substantially exerted.

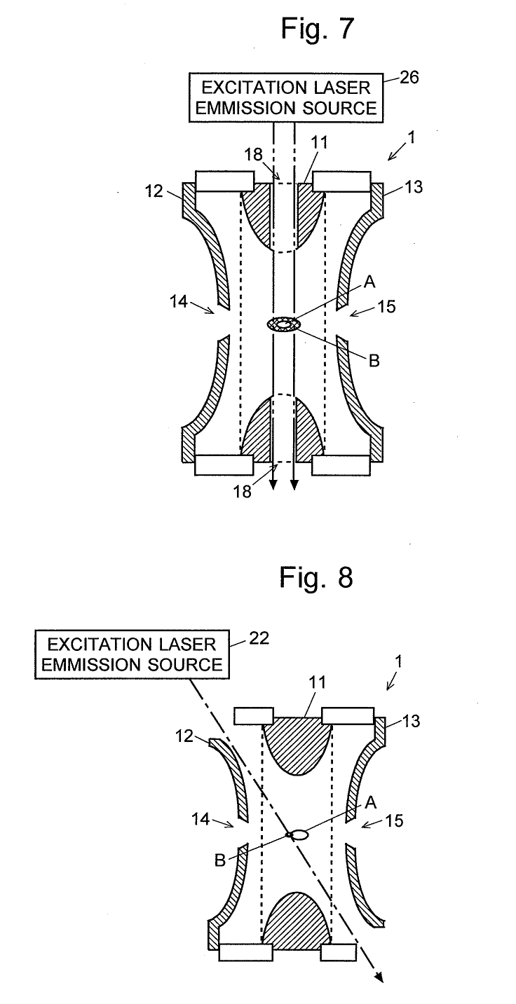

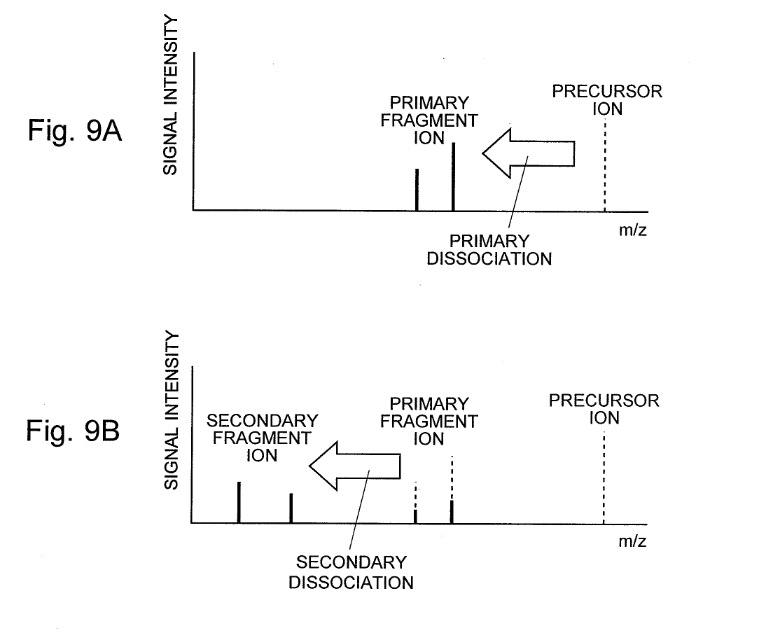

With the configuration illustrated in FIGS. 5 and 6, however, significantly elongating the time period while the precursor ions that vibrate with large amplitude is difficult. Hence, it is necessary to elongating the laser irradiation time in order to enhance the dissociation efficiency. Then, it is possible to modify the configuration of the ion trap 1 as illustrated in FIG. 7 so as to ensure that the precursor ions vibrated remain in the excitation light irradiated space B for a longer period of time. With this configuration, the excitation laser emission source 26 emits a laser light whose sectional form of the irradiated space has a circular shape. The laser light flies through the laser irradiation aperture 18 which is assuredly and cylindrically placed in the ring electrode 11 for example and forms the excitation light irradiated space B whose center portion is an unirradiated space and the surrounding area of the unirradiated space is an irradiated space. Such a laser light with a specific form can be generated, for example, by using a method disclosed in Japanese Unexamined Utility Model Application Publication No. 62-47959.

Since the excitation light irradiated space B is larger in this configuration, chances are high for precursor ions that vibrate by the excitation electric field to be irradiated by the excitation laser light. Hence, the precursor ion's dissociation efficiency increases as much. On the other hand, the fragment ions gathering around the center of the trapping space A are not irradiated by the excitation laser light. The secondary dissociation can be therefore prevented.

Although the excitation laser light was irradiated through the laser irradiation apertures 16, 17, and 18 which were bored through the ring electrode 11 in the aforementioned embodiment, the excitation laser light can be slantly irradiated through the gap between the ring electrode 11 and the end cap electrode 12 (or 13) as illustrated in FIG. 8. In this case, the configuration is simple since there is no need for placing a laser irradiation aperture in the ring electrode 1. Moreover, the ions' trapping efficiency can be enhanced since the disarrangement of the trapping space electric field based on the placement of a laser irradiation aperture in the ring electrode 11 dos not occur.

The embodiment described thus far is merely an embodiment of the present invention, and may be modified or changed within the scope of the present invention. For example, although a three-dimensional quadrupole type ion trap was used in the embodiments described earlier, a linear ion trap in which four (or more) rod electrodes whose inner surface is hyperboloidal or cylindrical are aligned parallel and a trapping space is formed in a space surrounded by the rod electrodes can also be used in the present invention.

What is claimed is:

1. A mass spectrometer for mass-analyzing ions generated by a dissociation in an ion trap, comprising:
an ion trap for trapping ions in a space surrounded by a plurality of electrodes;
an excitation light emitter for irradiating an excitation light for photo-dissociating ions to a center of a trapping space of the ion trap; and
an excitation signal generator for generating an excitation signal having a predetermined frequency that does not make precursor ions to be analyzed resonantly vibrate and selectively make fragment ions generated by a photodissociation resonantly vibrate, and for applying the excitation signal to at least one of the electrodes of the ion trap.

2. The mass spectrometer according to claim 1, further comprising a gas introducer for introducing a predetermined gas into the ion trap so as to control a reaction rate of the photodissociation.

3. A mass spectrometer for mass-analyzing ions generated by a dissociation in an ion trap, comprising:
an ion trap for trapping ions in a space surrounded by a plurality of electrodes;
an excitation light emitter for irradiating an excitation light for photo-dissociating ions to a space off a center of a trapping space of the ion trap; and
an excitation signal generator for generating an excitation signal having a predetermined frequency that selectively makes precursor ions to be analyzed resonantly vibrate to reach the excitation light irradiated space and does not make fragment ions generated by a photodissociation resonantly vibrate, and for applying the excitation signal to at least one of the electrodes of the ion trap.

4. The mass spectrometer according to claim 3, wherein the excitation light emitter emits an excitation light to surround a center of a trapping space of the ion trap.

5. The mass spectrometer according to claim 3, wherein the ion trap is a three-dimensional quadrupole type ion trap with one ring electrode and two end cap electrodes, and the excitation light irradiated area irradiated by the excitation light emitter is away from a center of the trapping space in the ion trap by 2.5% or above a distance between the end cap electrodes.

6. The mass spectrometer according to claim 3 wherein the ion trap is a linear ion trap in which a plurality of rod electrodes with curved inner surface are aligned parallel, and the excitation light irradiated area irradiated by the excitation light emitter is away from a center of the trapping space in the ion trap by 2.5% or above a distance between inner curved surfaces of two facing rod electrodes.
